(19) United States
(12) Patent Application Publication
(10) Pub. No.: US 2024/0062425 A1
(43) Pub. Date: Feb. 22, 2024

(54) Automatic Colorization of Grayscale Stereo Images

(71) Applicant: Meta Platforms Technologies, LLC, Menlo Park, CA (US)

(72) Inventors: Catherine Marie Herold, Zürich (CH); Alberto Garcia Garcia, Zürich (CH); Romain Bachy, Seattle, WA (US); Jan Oberländer, Binningen (CH); Ana Dodik, Zürich (CH); Ricardo da Silveira Cabral, Zürich (CH)

(21) Appl. No.: 17/890,123

(22) Filed: Aug. 17, 2022

(51) Int. Cl. G06T 7/90; G06V 10/77; G06T 7/73

(52) U.S. Cl. CPC G06T 7/90; G06V 10/77; G06T 7/74; G06T 2207/10024; G06T 2207/20081; G06T 2207/30244

(57) ABSTRACT

In one embodiment, a computing system may capture a first grayscale image using a first camera at a first camera pose and a second grayscale image using a second camera at a second camera pose. The computing system may capture a reference color image using an RGB camera at a third camera pose. The computing system may generate, using a colorization machine-learning model, a first color image with a same camera pose as the first camera pose based on the reference color image and the first grayscale image. The computing system may generate, using the colorization machine-learning model, a second color image with a same camera pose as the second camera pose based on the reference color image, the second grayscale image, and the first color image.

### TECHNICAL FIELD

This disclosure generally relates to computer graphics and 3D reconstruction techniques.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality.

Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers. When a user is wearing an HMD, his vision of the physical environment is occluded by the physical structure of the HMD. For example, the displays of the HMD could be positioned directly in front of and in close proximity to the user's eyes. Thus, whenever the user needs to see his physical surroundings, he would need to remove the HMD. Even if the removal of the HMD is temporary, doing so is inconvenient and disruptive to the user experience.

### SUMMARY OF PARTICULAR EMBODIMENTS

“Passthrough” is a feature that allows a user wearing an HMD to see his physical surroundings by displaying visual information captured by the HMD's front-facing cameras. To account for misalignment between the stereo cameras and the user's eyes and to provide parallax, the passthrough images are re-rendered based on a 3D model representation of the physical surrounding. The 3D model provides the rendering system geometry information, and the images captured by the HMD's cameras are used as texture images. However, the front-facing cameras of the HMD may only be able to capture grayscale images due to the resource limitations of the headset.

Embodiments described herein provide techniques for adding color to grayscale images. A machine-learning (“ML”) model may be trained to process a grayscale image and output a colored version of the image. Color generated by the machine-learning model, however, is prone to noise and inconsistencies. Color inconsistencies could be with respect to objects (e.g., the same object in a frame may have different patches of color), time (e.g., the same object appearing in different frames may have different colors), and stereo images (e.g., the same object appears in two images captured by the front-facing cameras may have different colors).

In particular embodiments, post-processing may be applied to the ML-generated color images to improve color consistency. In particular embodiments, post-processing may be based on affinity information between the pixels of the same grayscale image and between the pixels of different grayscale images (e.g., images captured at different times and/or stereo images). In particular embodiments, affinity information may be stored using one or more affinity matrices, which could, for example, identify the pixels in one or more corresponding images that should have the same color. This affinity between pixels could be defined spatially within the same image, across temporal images, and/or between stereo images. In particular embodiments, the affinity may be generated using the grayscale images based on heuristics. For example, for each pair of pixels within the same image, an affinity-determination module may consider their distance, grayscale values, and relevant factors to determine the strength of the affinity. Similarly, affinity values may be assigned for each pair of pixels between a sequence of two frames (e.g., affinity may be computed based on optical flow) and/or between a pair of stereo images (e.g., affinity may be computed by projecting the 3D point associated with a pixel in one image into the other image).

After the ML model generates a color image, each pixel's color may be adjusted according to the affinity matrices. For example, each pixel's color could be defined by a weighted average of other associate pixels specified in the affinity matrices. An optimization algorithm may be used to find the optimal color values that would best satisfy the color definitions for the pixels.

Depending on the number of pixels in the image, the affinity matrices in particular embodiments could be prohibitively large (e.g., 1M pixels would have 1M×1M affinities in the spatial domain alone). Since each pixel would usually only have a strong affinity towards a small percentage of the total pixels, the affinity relationship could instead be represented using eigenvectors. The most influential eigenvectors may then be used in the optimization process for determining color adjustments.

In particular embodiments, a computing system may perform colorization of a stereo grayscale image as described herein. Current artificial reality devices may include grayscale cameras that are typically used for stereo depth computation and other machine vision purposes. Additionally, grayscale cameras may be more cost effective to implement within an artificial reality device and the grayscale images can perform better in low light. The image feeds from these grayscale cameras may be used to provide passthrough visualization of the real world to the user. To improve upon the user experience, images provided in color may provide a more realistic experience to the user. To colorize the grayscale images, a third RGB monoscopic camera can be used to provide color information. The grayscale cameras coupled with a RGB monoscopic camera can be used to colorize the images captured by the grayscale cameras.

In particular embodiments, a colorization process of grayscale images can initially start with coloring a left grayscale image using known techniques. The coloring of the left grayscale image can start with an artificial reality device receiving a left grayscale image from the left grayscale camera and a central reference color image of the same scene. The images may be captured from two separate cameras (e.g., left grayscale camera and a centrally positioned RGB camera) from two different viewpoints to generate a left grayscale image and a color image. A visual geometry group (VGG) can be used to convert each of the left grayscale image and the color image into feature maps. A correlation map can be generated by determining a spatial correspondence between the feature map of the left grayscale image and the feature map of the color image. The color from the color image may be warped towards the left grayscale image to generate a colored version of the left grayscale image. A similarity map can be generated to indicate the reliability of the sampling of the reference color for each position in the colored version of the left grayscale image. A colorization neural network can use the warped color image (e.g., the colored left grayscale image) and the similarly map to generate a finalized colored left grayscale image.

In particular embodiments, after the left grayscale image is colorized, the colorization process can proceed with coloring the right grayscale image. The colorization process of the right grayscale image can follow the same steps as the left grayscale image, but the colorized left image can be used as an additional input to the colorization neural network to ensure color consistency between the left and the right colored images.

In particular embodiments, a generative adversarial network (GAN) may be used to train the colorization neural network. The output colored images can be provided to a discriminator, which is trained to determine whether the output colored images were actual color photographs or synthesized images. The ground truth for training can include the actual RGB photos of the left and right images. As an example, RGB cameras can be positioned in the same camera pose as grayscale images to obtain the ground truth colored images.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system worn by a user, in accordance with particular embodiments.

FIG. 1B illustrates an example of a passthrough feature, in accordance with particular embodiments.

FIG. 2 illustrates an optimized depth estimation technique that leverages a device's video encoder, in accordance with particular embodiments.

FIGS. 3A and 3B provide top-down illustrations of a 3D mesh being deformed to represent the contours of an observed environment, in accordance with particular embodiments.

FIG. 4 illustrates an example of a data structure that may be used to represent the 3D mesh, in accordance with particular embodiments.

FIG. 5 provides an illustration of 3D-passthrough rendering based on the 3D mesh, in accordance with particular embodiments.

FIG. 6 illustrates a block diagram for colorizing grayscale images, in accordance with particular embodiments.

FIG. 7 illustrates an example process for colorizing grayscale images, in accordance with particular embodiments.

FIG. 8 illustrates an example method for colorizing grayscale images, in accordance with particular embodiments.

FIG. 9 illustrates an example network environment associated with a VR or social-networking system.

FIG. 10 illustrates an example computer system.

### DESCRIPTION OF EXAMPLE EMBODIMENTS

“Passthrough” is a feature that allows a user to see his physical surroundings while wearing an HMD. Information about the user's physical environment is visually “passed through” to the user by having the HMD display information captured by the headset's external-facing cameras. Simply displaying the captured images would not work as intended, however. Since the locations and focal lengths of the cameras do not coincide with the locations and focal lengths of the user's eyes, the images captured by the cameras do not accurately reflect the user's perspective. In addition, since the images have no depth, simply displaying the images would not provide the user with proper parallax effects if he were to shift away from where the images were taken. Incorrect parallax, coupled with user motion, could lead to motion sickness. Thus, to generate correct parallax, particular embodiments of the passthrough feature extracts information about the environment from the captured images (e.g., depth information), use the information to generate a 3D model (a geometric scene representation) of the environment, and reconstruct a scene of the modeled environment from the user's current viewpoint.

Photon-to-visuals latency is another issue addressed by the passthrough feature. The delay between a photon hitting the camera and it appearing on the screen (as part of the captured image) determines the visual comfort of interacting in a dynamic world. Particular embodiments of the passthrough feature overcomes this issue by updating the 3D model representation of the environment based on images captured at a sufficiently high rate (e.g., at 30 Hz, 60 Hz, etc.) and rendering images based on the latest known head pose of the user.

In particular embodiments, a computing system may perform colorization of a stereo grayscale image as described herein. Current artificial reality devices may include grayscale cameras that are typically used for stereo depth computation and other machine vision purposes. Additionally, grayscale cameras may be more cost effective to implement within an artificial reality device and the grayscale images can perform better in low light. The image feeds from these grayscale cameras may be used to provide passthrough visualization of the real world to the user. To improve upon the user experience, images provided in color may provide a more realistic experience to the user. To colorize the grayscale images, a third RGB monoscopic camera can be used to provide color information. The grayscale cameras coupled with a RGB monoscopic camera can be used to colorize the images captured by the grayscale cameras.

In particular embodiments, a colorization process of grayscale images can initially start with coloring a left grayscale image using known techniques. The coloring of the left grayscale image can start with an artificial reality device receiving a left grayscale image from the left grayscale camera and a central reference color image of the same scene. The images may be captured from two separate cameras (e.g., left grayscale camera and a centrally positioned RGB camera) from two different viewpoints to generate a left grayscale image and a color image. A visual geometry group (VGG) can be used to convert each of the left grayscale image and the color image into feature maps. A correlation map can be generated by determining a spatial correspondence between the feature map of the left grayscale image and the feature map of the color image. The color from the color image may be warped towards the left grayscale image to generate a colored version of the left grayscale image. A similarity map can be generated to indicate the reliability of the sampling of the reference color for each position in the colored version of the left grayscale image. A colorization neural network can use the warped color image (e.g., the colored left grayscale image) and the similarly map to generate a finalized colored left grayscale image.

In particular embodiments, after the left grayscale image is colorized, the colorization process can proceed with coloring the right grayscale image. The colorization process of the right grayscale image can follow the same steps as the left grayscale image, but the colorized left image can be used as an additional input to the colorization neural network to ensure color consistency between the left and the right colored images.

In particular embodiments, a generative adversarial network (GAN) may be used to train the colorization neural network. The output colored images can be provided to a discriminator, which is trained to determine whether the output colored images were actual color photographs or synthesized images. The ground truth for training can include the actual RGB photos of the left and right images. As an example, RGB cameras can be positioned in the same camera pose as grayscale images to obtain the ground truth colored images.

In particular embodiments, a computing system may capture a first grayscale image using a first camera at a first camera pose and a second grayscale image using a second camera at a second camera pose. In particular embodiments, the computing system may be embodied as one or more of a smartphone, artificial reality device (e.g., AR/VR device), camera device, and the like. In particular embodiments, the first camera and the second camera may be external-facing cameras attached to an artificial reality device. The first camera may be coupled to the left side of the artificial reality device and the second camera may be coupled to the right side of the artificial reality device. In particular embodiments, the first camera and second camera may be grayscale cameras. Although this disclosure describes capturing images in a particular manner, this disclosure contemplates capturing images in any suitable manner.

In particular embodiments, the computing system may capture a reference color image using an RGB camera at a third camera pose. In particular embodiments, the RGB camera may be an external-facing camera coupled to an artificial reality device. In particular embodiments, the RGB camera may be coupled to the top center of an artificial reality device. In particular embodiments, the first camera pose may have a first viewpoint different from a second viewpoint associated with the third camera pose. In particular embodiments, the reference color image may be used to colorize one or more grayscale images. In particular embodiments, the computing system may convert the first grayscale image to a first feature map and the reference color image to a second feature map using a visual geometry group. In particular embodiments, the computing system may convert the second grayscale image to a third feature map. In particular embodiments, the computing system may determine a spatial correspondence between the first feature map and the second feature map to generate a correlation map. In particular embodiments, the computing system may determine a spatial correspondence between the second feature map and the third feature map to generate a correlation map. Although this disclosure describes capturing a reference image in a particular manner, this disclosure contemplates capturing a reference image in any suitable manner.

In particular embodiments, the computing system may generate first color image with a same camera pose as the first camera pose. In particular embodiments, the computing system may use a colorization machine-learning model to generate the first color image with the same camera pose as the first camera pose based on the reference color image and the first grayscale image. In particular embodiments, the computing system may warp color information from the reference color image to the first grayscale image based on the correlation map to generate a warped color image to generate the first color image. In particular embodiments, the computing system may generate a confidence map indicating the reliability of a sampling of a reference color for each position of the warped color image. In particular embodiments, generating the first color image may further be based on the warped color image and the confidence map. In particular embodiments, the colorization machine-learning model may be an encoder-decoder convolutional architecture. In particular embodiments, generating the first color image may further be based on one or more previously generated color images associated with the first camera pose. As an example and not by way of limitation, previous color images at the first camera pose may be used to generate a current color image at the first camera pose. Although this disclosure describes generated a color image in a particular manner, this disclosure contemplates generating a color image in any suitable manner.

In particular embodiments, the computing system may generate a second color image with a same camera pose as the second camera pose. In particular embodiments, the computing system may use a colorization machine-learning model to generate the second color image based on the reference color image, the second grayscale image, and the first color image. In particular embodiments, the computing system may warp color information from the reference color image to the second grayscale image to generate a warped color image based on the correlation map between the second grayscale image and the reference color image. In particular embodiments, the computing system may generate a confidence map indicating the reliability of a sampling of a reference color for each position of the warped color image. In particular embodiments, generating the second color image may further be based on the warped color image and the confidence map. In particular embodiments, generating the second color image may further be based on one or more previously generated color images associated with the second camera pose. Although this disclosure describes generated a color image in a particular manner, this disclosure contemplates generating a color image in any suitable manner.

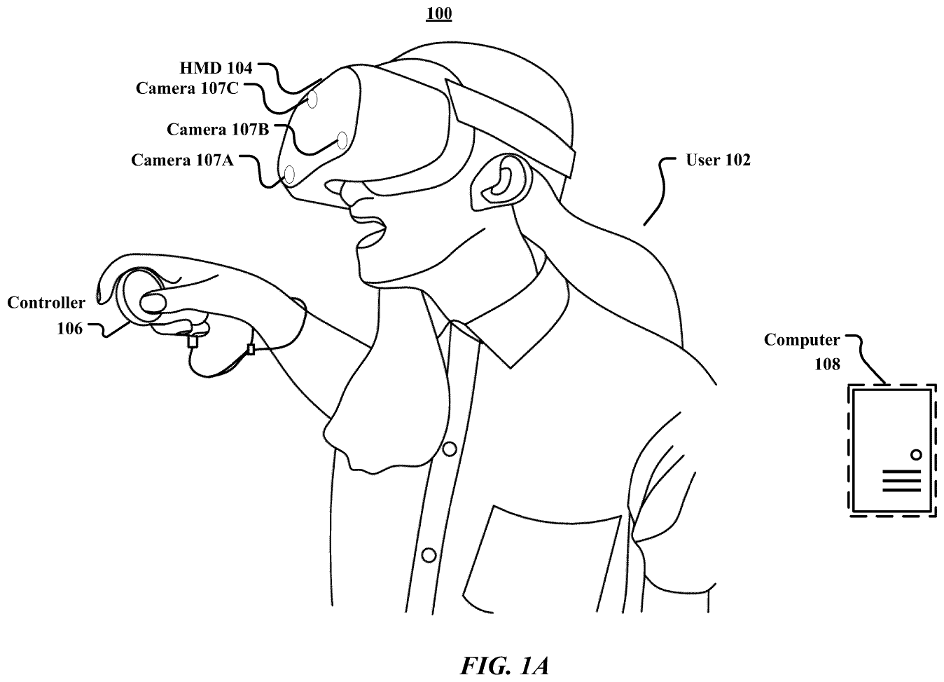

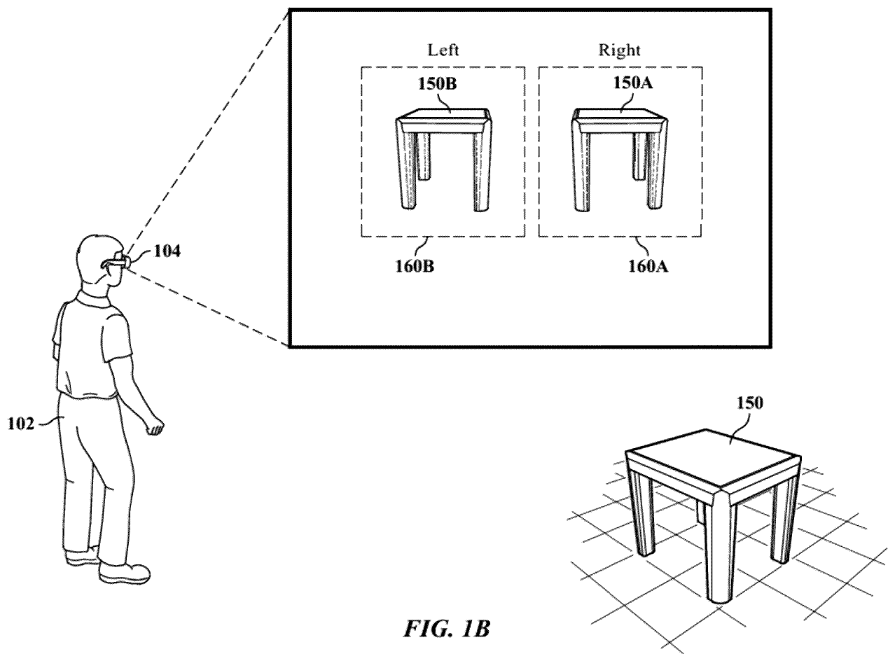

FIG. 1A illustrates an example of an artificial reality system 100 worn by a user 102. In particular embodiments, the artificial reality system 100 may comprise a head-mounted device (“HMD”) 104, a controller 106, and a computing system 108. The HMD 104 may be worn over the user's eyes and provide visual content to the user 102 through internal displays (not shown). The HMD 104 may have two separate internal displays, one for each eye of the user 102. As illustrated in FIG. 1A, the HMD 104 may completely cover the user's field of view. By being the exclusive provider of visual information to the user 102, the HMD 104 achieves the goal of providing an immersive artificial-reality experience. One consequence of this, however, is that the user 102 would not be able to see the physical environment surrounding him, as his vision is shielded by the HMD 104. As such, the passthrough feature described herein is needed to provide the user with real-time visual information about his physical surroundings. The HMD 104 may comprise several external-facing cameras 107A-107C. In particular embodiments, cameras 107A-107B may be grayscale cameras and camera 107C may be an RGB camera.

FIG. 1B illustrates an example of the passthrough feature. A user 102 may be wearing an HMD 104, immersed within a virtual reality environment. A physical table 150 is in the physical environment surrounding the user 102. However, due to the HMD 104 blocking the vision of the user 102, the user 102 is unable to see the table 150 directly. To help the user perceive his physical surroundings while wearing the HMD 104, the passthrough feature captures information about the physical environment using, for example, the aforementioned external-facing cameras 107A-107C. While the HMD 104 has three external-facing cameras 107A-107C, any combination of the cameras 107A-107C may be used to perform the functions as described herein. As an example and not by way of limitation, cameras 107A-107B may be used to perform one or more functions as described herein. In particular embodiments, the camera 107C may be used to capture RGB images to colorize the grayscale images captured by cameras 107A-107B as described herein. The captured information may then be re-projected to the user 102 based on his viewpoints. In particular embodiments where the HMD 104 has a right display 160A for the user's right eye and a left display 160B for the user's left eye, the system 100 may individually render (1) a re-projected view 150A of the physical environment for the right display 160A based on a viewpoint of the user's right eye and (2) a re-projected view 150B of the physical environment for the left display 160B based on a viewpoint of the user's left eye.

Referring again to FIG. 1A, the HMD 104 may have external-facing cameras, such as the three forward-facing cameras 107A-107C shown in FIG. 1A. While only three forward-facing cameras 107A-C are shown, the HMD 104 may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras are configured to capture the physical environment around the user and may do so continuously to generate a sequence of frames (e.g., as a video). As previously explained, although images captured by the forward-facing cameras 107A-C may be directly displayed to the user 102 via the HMD 104, doing so would not provide the user with an accurate view of the physical environment since the cameras 107A-C cannot physically be located at the exact same location as the user's eyes. As such, the passthrough feature described herein uses a re-projection technique that generates a 3D representation of the physical environment and then renders images based on the 3D representation from the viewpoints of the user's eyes.

The 3D representation may be generated based on depth measurements of physical objects observed by the cameras 107A-C. Depth may be measured in a variety of ways. In particular embodiments, depth may be computed based on stereo images. For example, the three forward-facing cameras 107A-C may share an overlapping field of view and be configured to capture images simultaneously. As a result, the same physical object may be captured by the cameras 107A-C at the same time. For example, a particular feature of an object may appear at one pixel p_{A} in the image captured by camera 107A, and the same feature may appear at another pixel p_{B} in the image captured by camera 107B. As long as the depth measurement system knows that the two pixels correspond to the same feature, it could use triangulation techniques to compute the depth of the observed feature. For example, based on the camera 107A's position within a 3D space and the pixel location of p_{A} relative to the camera 107A's field of view, a line could be projected from the camera 107A and through the pixel p_{A}. A similar line could be projected from the other camera 107B and through the pixel p_{B}. Since both pixels are supposed to correspond to the same physical feature, the two lines should intersect. The two intersecting lines and an imaginary line drawn between the two cameras 107A and 107B form a triangle, which could be used to compute the distance of the observed feature from either camera 107A or 107B or a point in space where the observed feature is located. The same can be done between either of cameras 107A-107B and camera 107C.

In particular embodiments, the pose (e.g., position and orientation) of the HMD 104 within the environment may be needed. For example, in order to render the appropriate display for the user 102 while he is moving about in a virtual environment, the system 100 would need to determine his position and orientation at any moment. Based on the pose of the HMD, the system 100 may further determine the viewpoint of either of the cameras 107A-107C or either of the user's eyes. In particular embodiments, the HMD 104 may be equipped with inertial-measurement units (“IMU”). The data generated by the IMU, along with the stereo imagery captured by the external-facing cameras 107A-107B, allow the system 100 to compute the pose of the HMD 104 using, for example, SLAM (simultaneous localization and mapping) or other suitable techniques.

In particular embodiments, the artificial reality system 100 may further have one or more controllers 106 that enable the user 102 to provide inputs. The controller 106 may communicate with the HMD 104 or a separate computing unit 108 via a wireless or wired connection. The controller 106 may have any number of buttons or other mechanical input mechanisms. In addition, the controller 106 may have an IMU so that the position of the controller 106 may be tracked. The controller 106 may further be tracked based on predetermined patterns on the controller. For example, the controller 106 may have several infrared LEDs or other known observable features that collectively form a predetermined pattern. Using a sensor or camera, the system 100 may be able to capture an image of the predetermined pattern on the controller. Based on the observed orientation of those patterns, the system may compute the controller's position and orientation relative to the sensor or camera.

The artificial reality system 100 may further include a computer unit 108. The computer unit may be a stand-alone unit that is physically separate from the HMD 104, or it may be integrated with the HMD 104. In embodiments where the computer 108 is a separate unit, it may be communicatively coupled to the HMD 104 via a wireless or wired link. The computer 108 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 100 depends on the capabilities of its computer unit 108.

In embodiments where the computing unit 108 is a high-performance device, an embodiment of the passthrough feature may be designed as follows. Through the external-facing cameras 107A-C of the HMD 104, a sequence of images of the surrounding physical environment may be captured. The information captured by the cameras 107A-C, however, would be misaligned with what the user's eyes would capture since the cameras could not spatially coincide with the user's eyes (e.g., the cameras would be located some distance away from the user's eyes and, consequently, have different viewpoints). As such, simply displaying what the cameras captured to the user would not be an accurate representation of what the user should perceive.

Instead of simply displaying what was captured, the passthrough feature would re-project information captured by the external-facing cameras 107A-C to the user. Each pair of simultaneously captured stereo images may be used to estimate the depths of observed features. As explained above, to measure depth using triangulation, the computing unit 108 would need to find correspondences between the stereo images. For example, the computing unit 108 would determine which two pixels in the pair of stereo images correspond to the same observed feature. A high-performance computing unit 108 may solve the correspondence problem using its GPU and optical flow techniques, which are optimized for such tasks. The correspondence information may then be used to compute depths using triangulation techniques. Based on the computed depths of the observed features, the computing unit 108 could determine where those features are located within a 3D space (since the computing unit 108 also knows where the cameras are in that 3D space). The result may be represented by a dense 3D point cloud, with each point corresponding to an observed feature. The dense point cloud may then be used to generate 3D models of objects in the environment. When the system renders a scene for display, the system could perform visibility tests from the perspectives of the user's eyes. For example, the system may cast rays into the 3D space from a viewpoint that corresponds to each eye of the user. In this manner, the rendered scene that is displayed to the user would be computed from the perspective of the user's eyes, rather than from the perspective of the external-facing cameras 107A-C.

The process described above, however, may not be feasible for a resource-limited computing unit (e.g., a mobile phone may be the main computational unit for the HMD). For example, unlike systems with powerful computational resources and ample energy sources, a mobile phone cannot rely on GPUs and computationally-expensive algorithms (e.g., optical flow) to perform depth measurements and generate an accurate 3D model of the environment. Thus, to provide passthrough on resource-limited devices, an optimized process is needed.

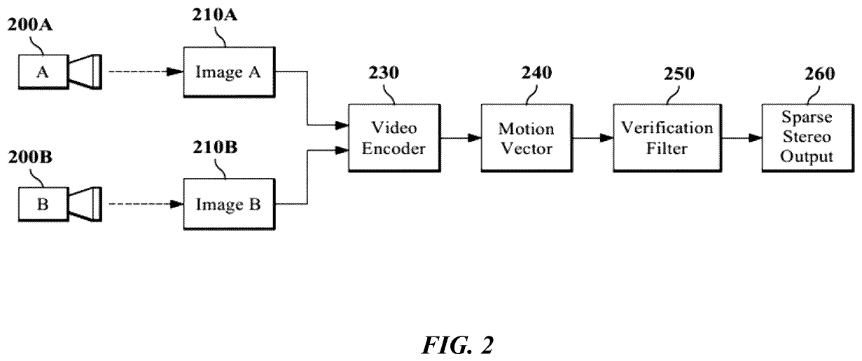

In particular embodiments, the computing device may be configured to dynamically determine, at runtime, whether it is capable of or able to generate depth measurements using (1) the GPU and optical flow or (2) the optimized technique using video encoder and motion vectors, as described in further detail below. For example, if the device has a GPU and sufficient power budget (e.g., it is plugged into a power source, has a full battery, etc.), it may perform depth measurements using its GPU and optical flow. However, if the device does not have a GPU or has a stringent power budget, then it may opt for the optimized method for computing depths, as described above with reference to FIG. 2.

FIG. 2 illustrates an optimized depth estimation technique that leverages a device's video encoder 230, in accordance with particular embodiments. A video encoder 230 (hardware or software) is designed to be used for video compression to predict the motion of pixels in successive video frames to avoid storing repetitions of the same pixel. It is common on any computing device capable of capturing and displaying video, even resource-limited ones like mobile phones. The video encoder 230 achieves compression by leveraging the temporal consistency that is often present between sequential frames. For example, in a video sequence captured by a camera that is moving relative to an environment, the frame-by-frame difference would likely be fairly minimal. Most objects appearing in one frame would continue to appear in the next, with only slight offsets relative to the frame due to changes in the camera's perspective. Thus, instead of storing the full color values of all the pixels in every frame, the video encoder predicts where the pixels in one frame (e.g., a frame at time t, represented by fₜ) came from in a previous frame (e.g., a frame at time t−1, represented by fₜ₋₁), or vice versa. The encoded frame may be referred to as a motion vector. Each grid or cell in the motion vector corresponds to a pixel in the frame fₜ that the motion vector is representing. The value in each grid or cell stores a relative offset in pixel space that identifies the likely corresponding pixel location in the previous frame fₜ₋₁. For example, if the pixel at coordinate (10, 10) in frame f t corresponds to the pixel at coordinate (7, 8) in the previous frame fₜ₋₁, the motion vector for frame f t would have grid or cell at coordinate (10, 10) that specifies a relative offset of (−3, −2) that could be used to identify the pixel coordinate (7, 8).

In particular embodiments, the correspondences between two stereo images may be computed using a device's video encoder. FIG. 2 shows two stereo cameras 200A and 200B that simultaneously capture a pair of stereo images 210A and 210B, respectively. Using an API provided for the device's video encoder, the passthrough feature may instruct the video encoder 230 to process the two stereo images 210A and 210B. However, since video encoders 230 are designed to find correspondence between sequential frames captured at a high frame rate (e.g., 30, 60, 80, or 100 frames-per-second), which means that sequential frames are likely very similar, having the video encoder 230 find correspondences between two simultaneously captured stereo images 210A-210B may yield suboptimal results. Thus, in particular embodiments, one or both of the images 210A-210B may undergo a translation based on the known physical separation between the two cameras 200A and 200B so that the images 210A and 210B would be more similar.

The output of the video encoder 230 may be a motion vector 240 that describes the predicted correspondences between images 210A and 210B using per-pixel offsets. The motion vector 240, however, could be noisy (i.e., many of the correspondences could be inaccurate). Thus, in particular embodiments, the motion vector 240 may undergo one or more verification filters 250 to identify the more reliable correspondence predictions. For example, one verification filter 250 may use the known geometry of the cameras 200A and 200B to determine epipolar lines for each pixel. Using the epipolar line associated with each pixel, the computing device could determine whether the corresponding pixel as identified by the motion vector 240 is a plausible candidate. For example, if the corresponding pixel falls on or within a threshold distance of the epipolar line, then the corresponding pixel may be deemed plausible. Otherwise, the corresponding pixel may be deemed implausible and the correspondence result would be rejected from being used in subsequent depth computations.

In particular embodiments, the verification filter 250 may assess the reliability of a correspondence found by the motion vector 240 based on temporal observations. This temporal filtering process may be applied to the original motion vector 240 or only to a subset of the motion vector 240 that survived the epipolar filtering process. For each correspondence undergoing the temporal filtering process, the system may compute the depth value using triangulation. The depth values may be represented as a point cloud in 3D space. The temporal filtering process may check whether the same points can be consistently observed through time. For example, the computing system may have a camera capture an image from a particular current perspective and compare it to a projection of the point cloud into a screen space associated with the current perspective. As an example, given the current perspective, the device may compute where, in screen space (e.g., the location of a particular pixel), the user should see each point in the point cloud. This may be done by projecting each point towards a point representation of the current perspective. As each point is being projected, it passed through a screen space of the current perspective. The location where the projected point intersects the screen space corresponds to a pixel location where that point is expected to appear. By comparing the projected pixel location to the same pixel location in the captured image, the system could determine whether the two pixels likely correspond to each other. If so, that point in the point cloud gets a positive vote; otherwise, it gets a negative vote. The points with a sufficiently high vote would be used as the final set of reliable points.

After the verification filtering process 250, the system would have a collection of stereo outputs or depth measurements 260. The collection 260 may be very sparse (or low resolution). For example, if each image has a resolution of 640×480 pixels, that means a high-accuracy correspondence could yield upwards of 307,200 depth measurements or points. Due to the noise and inaccuracy of the motion vector 240, the number of reliable points after the verification filtering process 250 may be in the range of, e.g., 1000-3000 points. Having a non-uniform density of the collection of depth measurements means that geometry information is lacking in certain regions. As such, particular embodiments may perform a densification process to fill in the missing depth information.

Once the computing device has generated a point cloud (whether dense or sparse) based on the depth measurements, it may generate a 3D mesh representation of a contour of the observed environment. For high-performance devices, accurate models of objects in the environment may be generated (e.g., each object, such as a table or a chair, may have its own 3D model). However, for resource-limited devices, the cost of generating such models and/or the underlying depth measurements for generating the models may be prohibitive. Thus, in particular embodiments, the 3D mesh representation for the environment may be a coarse approximation of the general contour of the objects in the environment. The 3D mesh, which may be represented as a depth map, may therefore have incomplete information (e.g., certain grids on the mesh may not have a corresponding verified depth measurement). In particular embodiments, a single 3D mesh may be used to approximate all the objects observed. Conceptually, the 3D mesh is analogous to a blanket or sheet that covers the entire observable surfaces in the environment.

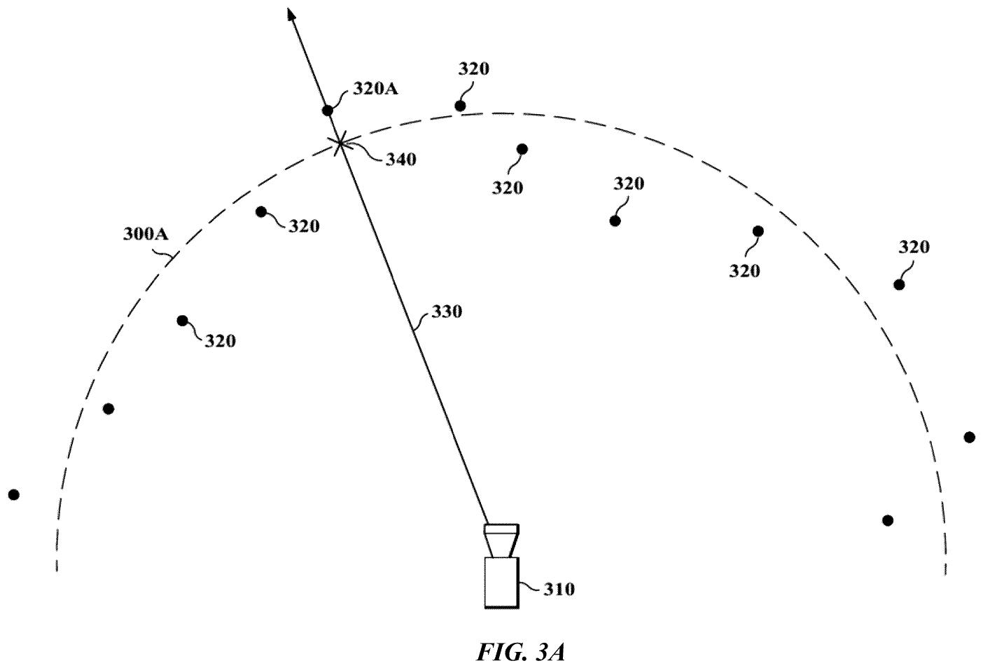

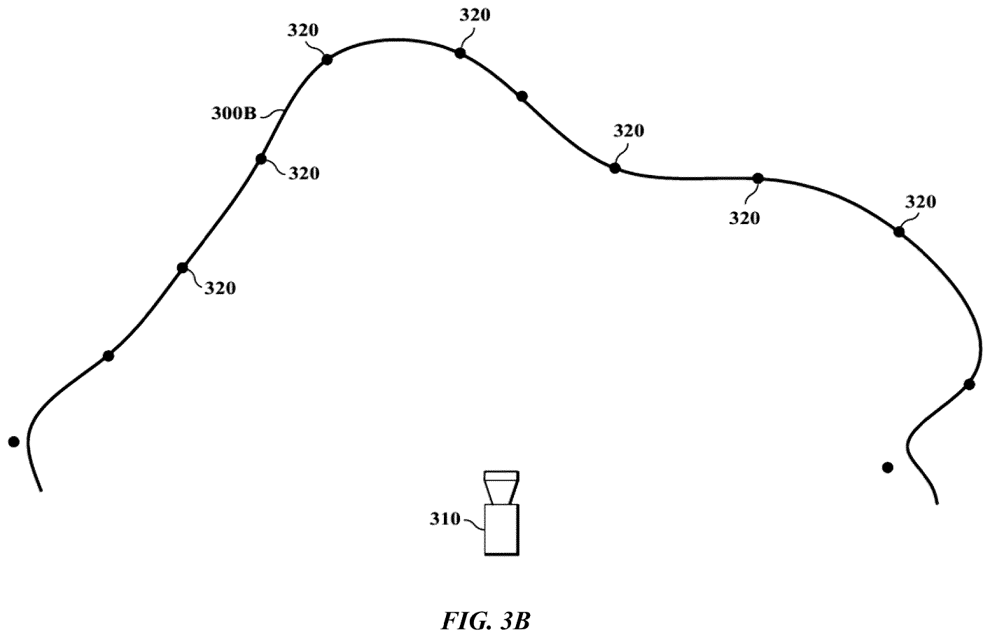

FIGS. 3A and 3B provide top-down illustrations of a 3D mesh being deformed to represent the contours of an observed environment. For clarity, the figures are drawn in 2D, but it should be understood that the 3D mesh is a 3D construct. FIG. 3A illustrates an embodiment of the 3D mesh 300A being initialized to be equal-distance (e.g., 1, 2, 2.5, or 3 meters) from a viewer 310 (represented by a camera). In the particular example shown, the radius of the 3D mesh 300A is 2 meters. Since the 3D mesh 300A is equal-distance away from the viewer 310, it forms a hemisphere around the user. For clarity, FIG. 3A illustrates a portion of a cross-section of that hemisphere, resulting in the half-circle shown. FIG. 3A further illustrates points (e.g., 320) in the point cloud that are deemed reliable. These points 320 represent observed features in the environment and may be generated using the embodiments described elsewhere herein.

The 3D mesh 300A may be deformed according to the points 320 in order to model the contour of the environment. In particular embodiments, the 3D mesh 300A may be deformed based on the viewer's 310 position and the points 320 in the point cloud. To determine which portion of the 3D mesh 300A corresponds to each point in the point cloud 320, the computing device may cast a conceptual ray from the viewer's 310 position towards that point. Each ray would intersect with a primitive (e.g., a triangle or other polygon) of the 3D mesh. For example, FIG. 3A shows a ray 330 being cast from the viewer 310 towards point 320A. The ray 330 intersects the 3D mesh 300A at a particular location 340. As a result, mesh location 340 is deformed based on the depth value associated with the point 320A. For example, if the point 320 is 2.2 meters away from the viewer 310, the depth value associated with the mesh location 340 may be updated to become 2.2 meters from its initial value of 2 meters. FIG. 3B illustrates the deformed 3D mesh 300B that may result from the deformation process. At this point, the deformed mesh 300B represents the contour of the physical environment observed by the viewer 310.

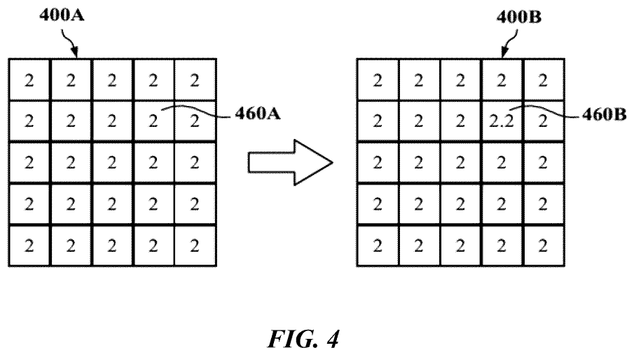

FIG. 4 illustrates an example of a data structure (e.g., a depth map) that may be used to represent the 3D mesh. In particular embodiments, the depth values that define the shape of the 3D mesh (e.g., mesh 300A shown in FIG. 3A) may be stored within a matrix 400A. The vertices of the primitives that form the mesh 300A may each have a corresponding cell in the matrix 400A, where the depth value of that vertex is stored. In particular embodiments, the coordinates of each cell within the matrix 400A may correspond to the radial coordinates of the vertex in the mesh, as measured relative to the viewer 310. Initially, the depth stored in each cell of the matrix 400A may be initialized to the same distance (e.g., 2 meters), which would result in the hemispheric mesh 300A shown in FIG. 3A. Based on the ray casting process described above, the depth values stored in the matrix 400A may be updated. For example, referring again to FIG. 3A, the ray 330 that was cast towards point 320A may intersect the mesh at location 340. The computing device may determine that the location 340 on the mesh 300A corresponds to cell 460A in the matrix 400A. The current depth stored in cell 460A may be updated to reflect the depth value of point 320A, which is 2.2 meters in the particular example given. As a result, the updated matrix 400B stores 2.2 as the depth value in the updated cell 460B. As previously mentioned, the number of verified depth measurements in the point cloud may be sparse, which in turn would lead to the mesh having incomplete information (e.g., a cell may not get updated). Thus, in particular embodiments, after the entire matrix has been updated based on the available points in the point cloud, the updated matrix may be processed using a Poisson smoothing technique (e.g., Poisson Solver) or any other suitable technique to, in effect, smooth the contours of the splines of the 3D mesh and filling missing depth values in the matrix. The Poisson smoothing technique is, therefore, being tasked to solve the problem of having incomplete depth data in the matrix representing the 3D mesh. The result is a 3D mesh contour that represents the depth of the observed world.

The mesh generated above may be computed from sparse 3D points (e.g., computed using motion vector stereo data). Changes in camera sensor noise lighting conditions, scene content, etc., may cause fluctuations in the sparse 3D point set. These fluctuations make their way into the mesh and may cause intermittent warping, bending, bubbling and wiggling of the resulting video frames rendered using the mesh. As previously described at least with reference to FIG. 2, the temporal smoothness problem may be alleviated by applying a temporal filter on the point cloud generated using, e.g., motion vectors. In particular embodiments described above, the point cloud resulting from the filtering process may then be projected onto a hemisphere to generate a 3D mesh, and a Poisson smoothing technique or any other suitable smoothing technique may be applied to fill in missing depth information and improve the smoothness of the mesh.

To further improve temporal smoothness, particular embodiments may generate the 3D mesh (or its corresponding depth map data structure) using not only the sparse point cloud (e.g., the vetted points that survived the filtering process) generated from the current image capture but also additional points from completed 3D meshes generated in previous time instances. For example, at a current time t, a 3D mesh may be generated based on (1) the sparse point cloud generated using images observed at time t and (2) the 3D mesh generated for time t−1. Since the 3D depth information at time t−1 is relative to the user's viewpoint at time t−1, that 3D depth information would need to be projected to the current user's viewpoint at time t. The projected depth information may then supplement the point cloud generated at time t. The supplemented data set of depth information may then be used to generate a 3D mesh (e.g., by projecting the points in the supplemented data set onto a hemisphere). The generated 3D mesh may in turn be processed using a Poisson smoothing technique or any other suitable smoothing technique to fill in missing depth information and improve the smoothness of the mesh.

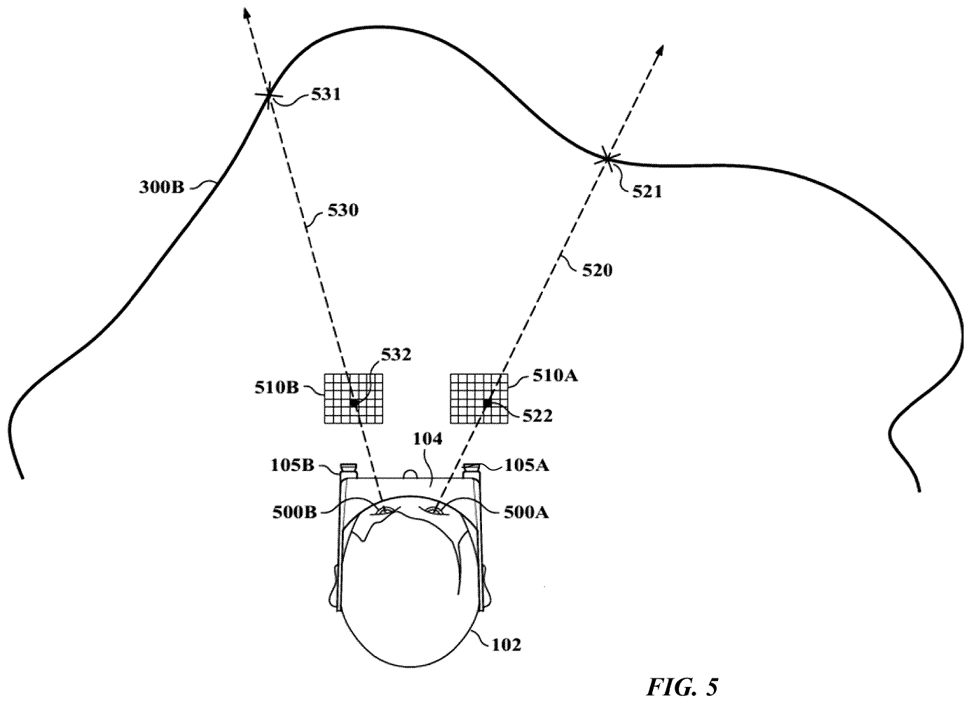

FIG. 5 provides an illustration of 3D-passthrough rendering based on the 3D mesh. In particular embodiments, the rendering system may determine the user's 102 current viewing position relative to the environment. In particular embodiments, the system may compute the pose of the HMD 104 using SLAM or other suitable techniques. Based on the known mechanical structure of the HMD 104, the system could then estimate the viewpoints of the user's eyes 500A and 500B using offsets from the pose of the HMD 104. The system may then render a passthrough image for each of the user's eyes 500A-B. For example, to render a passthrough image for the user's right eye 500A, the system may cast a ray 520 from the estimated viewpoint of the right eye 500A through each pixel of a virtual screen space 510A to see which portion of the mesh 300B the rays would intersect. This ray casting process may be referred to as a visibility test, as the objective is to determine what is visible from the selected viewpoint 500A. In the particular example shown, the ray 520 projected through a particular pixel 522 intersects with a particular point 521 on the mesh. This indicates that the point of intersection 521 is to be displayed by the pixel 522. Once the point of intersection 521 is found, the rendering system may sample a corresponding point in a texture image that is mapped to the point of intersection 521. In particular embodiments, the image captured by the cameras 107A-B of the HMD 104 may be used to generate a texture for the mesh 300B. Doing so allows the rendered image to appear more like the actual physical object. In a similar manner, the rendering system may render a passthrough image for the user's left eye 500B. In the example shown, a ray 530 may be cast from the left-eye viewpoint 500B through pixel 532 of the left screen space 510B. The ray 530 intersects the mesh 300B at location 531. The rendering system may then sample a texture image at a texture location corresponding to the location 531 on the mesh 300B and compute the appropriate color to be displayed by pixel 532. Since the passthrough images are re-rendered from the user's viewpoints 500A-B, the images would appear natural and provide proper parallax effect.

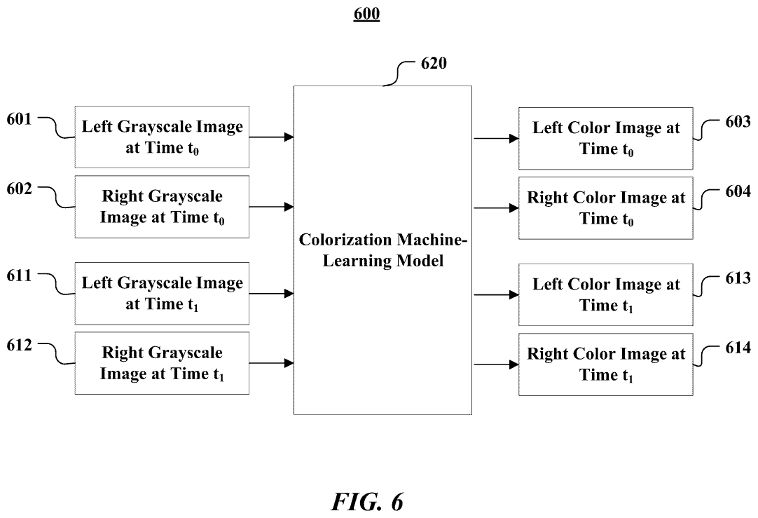

In particular embodiments, images captured by the HMD, which may be used as texture images for rendering passthrough visualization, may be in grayscale. Consequently, the passthrough visualization would also be in grayscale. To provide color, particular embodiments may use a machine-learning model to colorize the grayscale images. FIG. 6 illustrates a block diagram 600 for colorizing grayscale images. The block diagram 600 illustrates two pairs of stereo images captured at different times, time to and time ti (e.g., the stereo images may be video frames). Specifically, block diagram 600 shows a stereo pair of left 601 and right 602 grayscale images captured at time to and another stereo pair of left 611 and right 612 grayscale images captured at time ti. The images 601, 602, 611, 612 may be processed by a colorization machine-learning model 620 to generate corresponding colorized images 603, 604, 613, 614, respectively. The colorization machine-learning model 620 may be trained to transform grayscale images into color images. For example, the colorization model 620 (e.g., a neural network, such as a convolutional neural network) may be trained on a set of training samples that each has a grayscale image and a corresponding colored version of the same image (the ground truth). During a training iteration, the colorization ML model 620 may process the grayscale image of a training sample and generate an output color image. The output color image may then be compared to the ground-truth color image of the training sample using a loss function. The loss function may quantify the error between the output color image and the ground-truth color image. The quantified error may then be used to update the parameters of the colorization ML model 620 (e.g., via backpropagation) so that it would perform better in the next iteration.

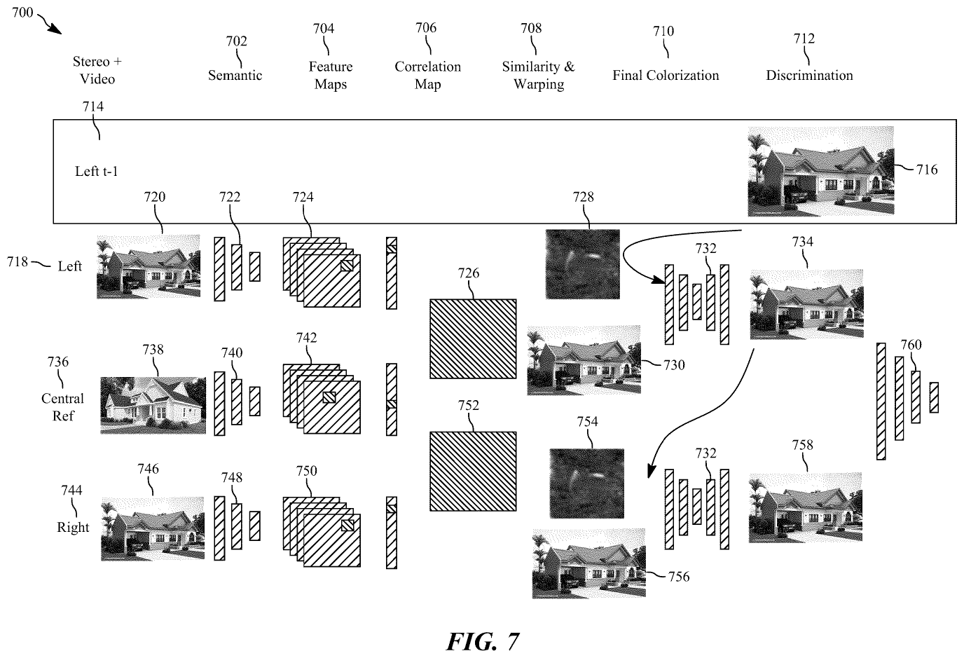

FIG. 7 illustrates an example process 700 for colorizing grayscale images. In particular embodiments, a computing system may perform the process 700 as described herein. In particular embodiments, the computing system may be embodied as an artificial reality system. As an example and not by way of limitation, the artificial reality system may be embodied as an AR/VR device. The process 700 may include semantic analysis 702, feature map generation 704, correlation map generation 706, a similarity & warping phase 708, a final colorization 710, and discrimination 712. The inputs into the colorization process 700 may include one or more previous left color images 714, one or more left grayscale images 718, one or more central reference color images 736, and one or more right grayscale images 744. In particular embodiments, one or more external-facing cameras of the computing system may capture one or more inputs into the process 700. In particular embodiments, the computing system may generate one or more inputs into the process 700. In particular embodiments, the computing system may use a left grayscale camera to capture the one or more left grayscale images 714. In particular embodiments, the computing system may use a central RGB camera to capture the one or more central reference color images 736. In particular embodiments, the computing system may use a right grayscale camera to capture the one or more right grayscale images 744. In particular embodiments, the computing system may generate one or more previous left color images 714 using the process 700.

In particular embodiments, the process 700 may start with a computing system accessing one or more previous left color images 714. In particular embodiments, the computing system may retrieve a previous left color image 716. As an example and not by way of limitation, the computing system may store one or more previously generated left color images 714 in a datastore to be accessed. As another example and not by way of limitation, the computing system may use the previously generated left color image 716 from the previous frame.

In particular embodiments, the process 700 may continue with the computing system receiving a left grayscale image 720 from a left grayscale camera of the computing system. The computing system may perform a semantic analysis 722 on the left grayscale image 720. As an example and not by way of limitation, the semantic analysis 722 may be performed to identify one or more objects within the left grayscale image 720. In particular embodiments, the computing system may use a visual geometry group for feature map generation 704 to generate a feature map 724 of the left grayscale image 720. In particular embodiments, the computing system may receive a central reference color image 738 from an RGB camera of the computing system. The computing system may also perform a semantic analysis 702 on the central reference color image 738. As an example and not by way of limitation, the semantic analysis 740 may be performed to identify one or more objects within the central reference color image 738. In particular embodiments, the computing system may use a visual geometry group for feature map generation 704 to generate a feature map 742 of the central reference color image 738.

In particular embodiments, the process 700 may continue with the computing system performing correlation map generation 706 to generate a correlation map 726 by determining a spatial correspondence between the feature map 724 of the left grayscale image 720 and the feature map 742 of the central reference color image 738. In particular embodiments, the process 700 may continue with the computing system performing a similarity & warping phase 708, where the computing system may warp the color from the central reference color image 738 towards the left grayscale image 720 to generate a warped image 730. The computing system may generate a similarity map 728 to indicate the reliability of the sampling of the reference color for each position in the warped colored version 730 of the left grayscale image 720. A colorization neural network 732 can use the warped color image 730 (e.g., the colored left grayscale image) and the similarly map 728 to generate a finalized colored left grayscale image 734. In particular embodiments, the colorization neural network 732 may also use a previous left color image 716 to generate the finalized colored left grayscale image 734.

In particular embodiments, the process 700 may continue with the computing system receiving a right grayscale image 746 from a right grayscale camera of the computing system. The computing system may perform a semantic analysis 748 on the right grayscale image 746. As an example and not by way of limitation, the semantic analysis 748 may be performed to identify one or more objects within the right grayscale image 746. In particular embodiments, the computing system may use a visual geometry group for feature map generation 704 to generate a feature map 750 of the right grayscale image 746. In particular embodiments, the computing system may perform correlation map generation 706 to generate a correlation map 752 by determining a spatial correspondence between the feature map 742 of central reference color image 738 and the feature map 750 of the right grayscale image 746. In particular embodiments, the process 700 may continue with the computing system performing a similarity & warping phase 708, where the computing system may warp the color from the central reference color image 738 towards the right grayscale image 746 to generate a warped image 756. The computing system may generate a similarity map 754 to indicate the reliability of the sampling of the reference color for each position in the warped colored version 756 of the right grayscale image 746. A colorization neural network 732 can use the warped color image 756 (e.g., the colored right grayscale image) and the similarly map 754 to generate a finalized colored right grayscale image 758. In particular embodiments, the colorization neural network 732 may also use a finalized colored left grayscale image 734 to generate the finalized colored right grayscale image 758.

In particular embodiments, the process 700 may continue where the computing system may use the finalized colored left grayscale image 734 and the finalized colored right grayscale image 758 to provide to a discriminator 760 for a discrimination process 712 which is trained to determine whether the output colored images were actual color photographs or synthesized images.

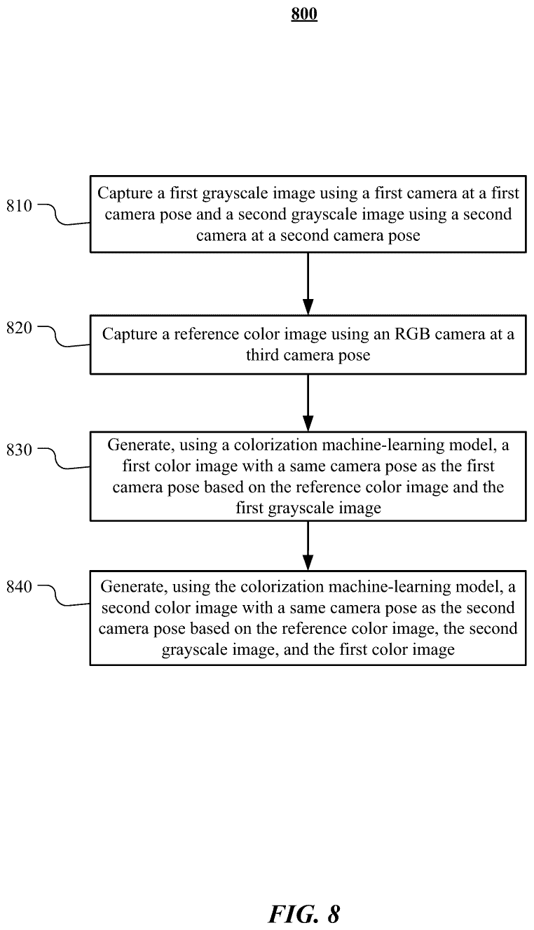

FIG. 8 illustrates an example method 800 for colorizing grayscale images. The method may begin at step 810, where a computing system may capture a first grayscale image using a first camera at a first camera pose and a second grayscale image using a second camera at a second camera pose. Although only two images are described this disclosure contemplates any number of other images. As an example and not by way of limitation, there may be an additional camera that captures another grayscale image at a different camera pose from the first camera pose and the second camera pose. In particular embodiments, the computing system may access a first grayscale image and a second grayscale image (or any other number of images). The two images may be a pair of stereo images (e.g., the first grayscale image and the second grayscale image may be simultaneously captured by, respectively, a first camera and a second camera having an overlapping field of view) or a pair of temporally-related images (e.g., captured sequentially by the same camera). In particular embodiments, the computing system may further access a third grayscale image, in which case the first and second grayscale images may be a pair of stereo images and the first and third grayscale images may be a pair of temporally-related images.

At step 820, the computing system may capture a reference color image using an RGB camera at a third camera pose. In particular embodiments, the computing system may capture multiple reference color images using one or more RGB cameras at different camera poses. In particular embodiments, the third camera pose may be different from either the first camera pose or the second camera pose. As an example and not by way of limitation, the first camera may be coupled to a left side of the computing system and the second camera may be coupled to a right side of the computing system and the third camera may be coupled to a center of the computing system.

At step 830, the computing system may generate a first color image based on the reference color image and the first grayscale image. In particular embodiments, the computing system may use a colorization machine-learning model to generate the first color image. In particular embodiments, the first color image may be in the same camera pose as the first camera pose. As an example and not by way of limitation, the first color image may contain the same objects in the same orientation as the first grayscale image with color added to each of the objects.

At step 840, the computing system may generate a second color image based on the reference color image, the second grayscale image, and the first color image. In particular embodiments, the computing system may use a colorization machine-learning model to generate the second color image. In particular embodiments, the second color image may be in the same camera pose as the second grayscale image. As an example and not by way of limitation, the second color image may contain the same objects in the same orientation as the second grayscale image with color added to each of the objects. If additional grayscale images are to be colorized, the system may further generate a third color image based on a third grayscale image, a fourth color image based on a fourth grayscale image, and so on.

In particular embodiments, the computing system may generate a first visual output based on the first color image and a second visual output based on the second color image. For example, the first and second visual outputs may be passthrough visualizations of the user's physical environment, in which case the first and second color images may be used as textures for rendering the passthrough visualizations. If the first and second color images are a pair of stereo images, the first and second visual outputs may be simultaneously displayed by the left and right screens of a stereo display. On the other hand, if the first and second color images are a pair of temporally-related images, the first and second visual outputs may be displayed sequentially on the same screen of a display (e.g., the left-eye screen).

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for colorizing grayscale images, including the particular steps of the method of FIG. 8, this disclosure contemplates any suitable method for colorizing grayscale images, including any suitable steps, which may include a subset of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

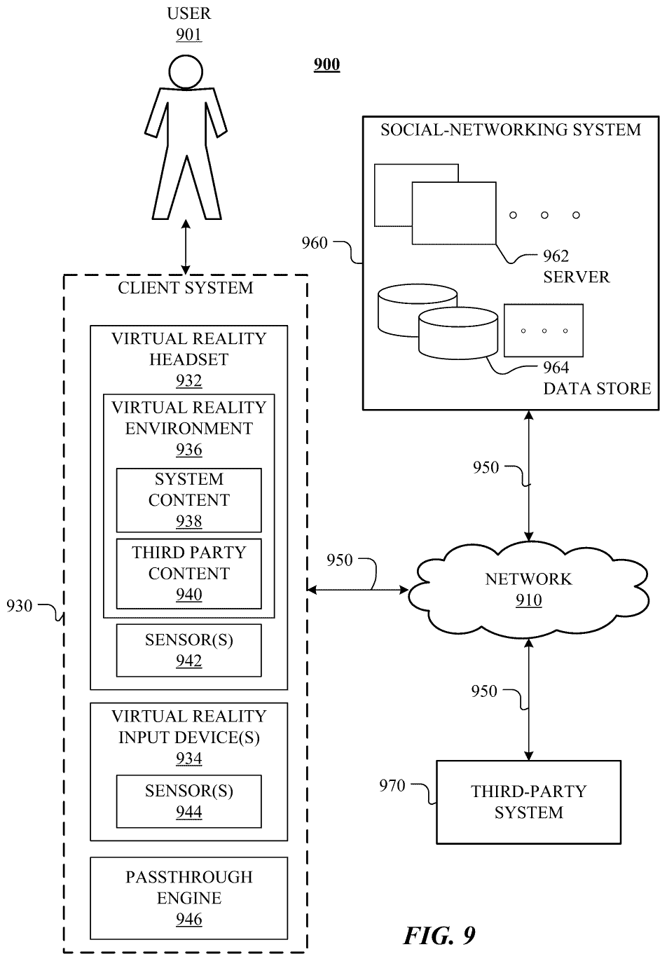

FIG. 9 illustrates an example network environment 900 associated with a virtual reality system. Network environment 900 includes a user 901 interacting with a client system 930, a social-networking system 960, and a third-party system 970 connected to each other by a network 910. Although FIG. 9 illustrates a particular arrangement of a user 901, a client system 930, a social-networking system 960, a third-party system 970, and a network 910, this disclosure contemplates any suitable arrangement of a user 901, a client system 930, a social-networking system 960, a third-party system 970, and a network 910. As an example and not by way of limitation, two or more of a user 901, a client system 930, a social-networking system 960, and a third-party system 970 may be connected to each other directly, bypassing a network 910. As another example, two or more of a client system 930, a social-networking system 960, and a third-party system 970 may be physically or logically co-located with each other in whole or in part. Moreover, although FIG. 9 illustrates a particular number of users 901, client systems 930, social-networking systems 960, third-party systems 970, and networks 910, this disclosure contemplates any suitable number of client systems 930, social-networking systems 960, third-party systems 970, and networks 910. As an example and not by way of limitation, network environment 900 may include multiple users 901, client systems 930, social-networking systems 960, third-party systems 970, and networks 910.

This disclosure contemplates any suitable network 910. As an example and not by way of limitation, one or more portions of a network 910 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 910 may include one or more networks 910.

Links 950 may connect a client system 930, a social-networking system 960, and a third-party system 970 to a communication network 910 or to each other. This disclosure contemplates any suitable links 950. In particular embodiments, one or more links 950 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 950 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 950, or a combination of two or more such links 950. Links 950 need not necessarily be the same throughout a network environment 900. One or more first links 950 may differ in one or more respects from one or more second links 950.

In particular embodiments, a client system 930 may be an electronic device including hardware, software, or embedded logic components or a combination of two or more such components and capable of carrying out the appropriate functionalities implemented or supported by a client system 930. As an example and not by way of limitation, a client system 930 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 930. A client system 930 may enable a network user at a client system 930 to access a network 910. A client system 930 may enable its user to communicate with other users at other client systems 930. A client system 930 may generate a virtual reality environment for a user to interact with content.

In particular embodiments, a client system 930 may include a virtual reality (or augmented reality) headset 932, such as OCULUS RIFT and the like, and virtual reality input device(s) 934, such as a virtual reality controller. A user at a client system 930 may wear the virtual reality headset 932 and use the virtual reality input device(s) to interact with a virtual reality environment 936 generated by the virtual reality headset 932. Although not shown, a client system 930 may also include a separate processing computer and/or any other component of a virtual reality system. A virtual reality headset 932 may generate a virtual reality environment 936, which may include system content 938 (including but not limited to the operating system), such as software or firmware updates and also include third-party content 940, such as content from applications or dynamically downloaded from the Internet (e.g., web page content). A virtual reality headset 932 may include sensor(s) 942, such as accelerometers, gyroscopes, magnetometers to generate sensor data that tracks the location of the headset device 932. The headset 932 may also include eye trackers for tracking the position of the user's eyes or their viewing directions. The client system may use data from the sensor(s) 942 to determine velocity, orientation, and gravitation forces with respect to the headset. Virtual reality input device(s) 934 may include sensor(s) 944, such as accelerometers, gyroscopes, magnetometers, and touch sensors to generate sensor data that tracks the location of the input device 934 and the positions of the user's fingers. The client system 930 may make use of outside-in tracking, in which a tracking camera (not shown) is placed external to the virtual reality headset 932 and within the line of sight of the virtual reality headset 932. In outside-in tracking, the tracking camera may track the location of the virtual reality headset 932 (e.g., by tracking one or more infrared LED markers on the virtual reality headset 932). Alternatively or additionally, the client system 930 may make use of inside-out tracking, in which a tracking camera (not shown) may be placed on or within the virtual reality headset 932 itself. In inside-out tracking, the tracking camera may capture images around it in the real world and may use the changing perspectives of the real world to determine its own position in space.

In particular embodiments, client system 930 (e.g., an HMD) may include a passthrough engine 946 to provide the passthrough feature described herein, and may have one or more add-ons, plug-ins, or other extensions. A user at client system 930 may connect to a particular server (such as server 962, or a server associated with a third-party system 970). The server may accept the request and communicate with the client system 930.

Third-party content 940 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 930 may enter a Uniform Resource Locator (URL) or other address directing a web browser to a particular server (such as server 962, or a server associated with a third-party system 970), and the web browser may generate a Hyper Text Transfer Protocol (HTTP) request and communicate the HTTP request to server. The server may accept the HTTP request and communicate to a client system 930 one or more Hyper Text Markup Language (HTML) files responsive to the HTTP request. The client system 930 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 960 may be a network-addressable computing system that can host an online social network. The social-networking system 960 may generate, store, receive, and send social-networking data, such as, for example, user-profile data, concept-profile data, social-graph information, or other suitable data related to the online social network. The social-networking system 960 may be accessed by the other components of network environment 900 either directly or via a network 910. As an example and not by way of limitation, a client system 930 may access the social-networking system 960 using a web browser of a third-party content 940, or a native application associated with the social-networking system 960 (e.g., a mobile social-networking application, a messaging application, another suitable application, or any combination thereof) either directly or via a network 910. In particular embodiments, the social-networking system 960 may include one or more servers 962. Each server 962 may be a unitary server or a distributed server spanning multiple computers or multiple datacenters. Servers 962 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 962 may include hardware, software, or embedded logic components or a combination of two or more such components for carrying out the appropriate functionalities implemented or supported by server 962. In particular embodiments, the social-networking system 960 may include one or more data stores 964. Data stores 964 may be used to store various types of information. In particular embodiments, the information stored in data stores 964 may be organized according to specific data structures. In particular embodiments, each data store 964 may be a relational, columnar, correlation, or other suitable database. Although this disclosure describes or illustrates particular types of databases, this disclosure contemplates any suitable types of databases. Particular embodiments may provide interfaces that enable a client system 930, a social-networking system 960, or a third-party system 970 to manage, retrieve, modify, add, or delete, the information stored in data store 964.

In particular embodiments, the social-networking system 960 may store one or more social graphs in one or more data stores 964. In particular embodiments, a social graph may include multiple nodes—which may include multiple user nodes (each corresponding to a particular user) or multiple concept nodes (each corresponding to a particular concept)—and multiple edges connecting the nodes. The social-networking system 960 may provide users of the online social network the ability to communicate and interact with other users. In particular embodiments, users may join the online social network via the social-networking system 960 and then add connections (e.g., relationships) to a number of other users of the social-networking system 960 whom they want to be connected to. Herein, the term “friend” may refer to any other user of the social-networking system 960 with whom a user has formed a connection, association, or relationship via the social-networking system 960.

In particular embodiments, the social-networking system 960 may provide users with the ability to take actions on various types of items or objects, supported by the social-networking system 960. As an example and not by way of limitation, the items and objects may include groups or social networks to which users of the social-networking system 960 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 960 or by an external system of a third-party system 970, which is separate from the social-networking system 960 and coupled to the social-networking system 960 via a network 910.

In particular embodiments, the social-networking system 960 may be capable of linking a variety of entities. As an example and not by way of limitation, the social-networking system 960 may enable users to interact with each other as well as receive content from third-party systems 970 or other entities, or to allow users to interact with these entities through an application programming interfaces (API) or other communication channels.

In particular embodiments, a third-party system 970 may include one or more types of servers, one or more data stores, one or more interfaces, including but not limited to APIs, one or more web services, one or more content sources, one or more networks, or any other suitable components, e.g., that servers may communicate with. A third-party system 970 may be operated by a different entity from an entity operating the social-networking system 960. In particular embodiments, however, the social-networking system 960 and third-party systems 970 may operate in conjunction with each other to provide social-networking services to users of the social-networking system 960 or third-party systems 970. In this sense, the social-networking system 960 may provide a platform, or backbone, which other systems, such as third-party systems 970, may use to provide social-networking services and functionality to users across the Internet.

In particular embodiments, a third-party system 970 may include a third-party content object provider. A third-party content object provider may include one or more sources of content objects, which may be communicated to a client system 930. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 960 also includes user-generated content objects, which may enhance a user's interactions with the social-networking system 960. User-generated content may include anything a user can add, upload, send, or “post” to the social-networking system 960. As an example and not by way of limitation, a user communicates posts to the social-networking system 960 from a client system 930. Posts may include data such as status updates or other textual data, location information, photos, videos, links, music or other similar data or media. Content may also be added to the social-networking system 960 by a third-party through a “communication channel,” such as a newsfeed or stream.

In particular embodiments, the social-networking system 960 may include a variety of servers, sub-systems, programs, modules, logs, and data stores. In particular embodiments, the social-networking system 960 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 960 may also include suitable components such as network interfaces, security mechanisms, load balancers, failover servers, management-and-network-operations consoles, other suitable components, or any suitable combination thereof. In particular embodiments, the social-networking system 960 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 960 to one or more client systems 930 or one or more third-party systems 970 via a network 910. The web server may include a mail server or other messaging functionality for receiving and routing messages between the social-networking system 960 and one or more client systems 930. An API-request server may allow a third-party system 970 to access information from the social-networking system 960 by calling one or more APIs. An action logger may be used to receive communications from a web server about a user's actions on or off the social-networking system 960. In conjunction with the action log, a third-party-content-object log may be maintained of user exposures to third-party-content objects. A notification controller may provide information regarding content objects to a client system 930. Information may be pushed to a client system 930 as notifications, or information may be pulled from a client system 930 responsive to a request received from a client system 930. Authorization servers may be used to enforce one or more privacy settings of the users of the social-networking system 960. A privacy setting of a user determines how particular information associated with a user can be shared. The authorization server may allow users to opt in to or opt out of having their actions logged by the social-networking system 960 or shared with other systems (e.g., a third-party system 970), such as, for example, by setting appropriate privacy settings. Third-party-content-object stores may be used to store content objects received from third parties, such as a third-party system 970. Location stores may be used for storing location information received from client systems 930 associated with users. Advertisement-pricing modules may combine social information, the current time, location information, or other suitable information to provide relevant advertisements, in the form of notifications, to a user.

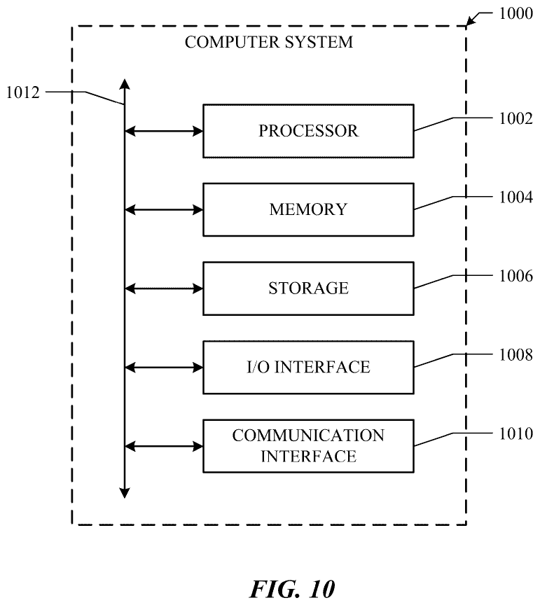

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
capturing a first grayscale image using a first camera at a first camera pose and a second grayscale image using a second camera at a second camera pose;
capturing a reference color image using an RGB camera at a third camera pose;
generating, using a colorization machine-learning model, a first color image with a same camera pose as the first camera pose based on the reference color image and the first grayscale image; and
generating, using the colorization machine-learning model, a second color image with a same camera pose as the second camera pose based on the reference color image, the second grayscale image, and the first color image.

2. The method of claim 1, wherein the first camera pose has a first viewpoint different from a second viewpoint associated with the third camera pose.

3. The method of claim 1, further comprising:
converting, using a visual geometry group, the first grayscale image to a first feature map and the reference color image to a second feature map; and
determining a spatial correspondence between the first feature map and the second feature map to generate a correlation map.

4. The method of claim 3, wherein generating the first color image further comprises:
warping color information from the reference color image to the first grayscale image based on the correlation map to generate a warped color image; and
generating a confidence map indicating the reliability of a sampling of a reference color for each position of the warped color image, wherein generating the first color image is further based on the warped color image and the confidence map.

5. The method of claim 1, wherein the colorization machine-learning model is an encoder-decoder convolutional architecture.

6. The method of claim 1, wherein generating the first color image is further based on one or more previously generated color images associated with the first camera pose.

7. The method of claim 1, wherein generating the second color image is further based on one or more previously generated color images associated with the second camera pose.

8. One or more computer-readable non-transitory storage media embodying software that is operable when executed to:
capture a first grayscale image using a first camera at a first camera pose and a second grayscale image using a second camera at a second camera pose;
capture a reference color image using an RGB camera at a third camera pose;
generate, using a colorization machine-learning model, a first color image with a same camera pose as the first camera pose based on the reference color image and the first grayscale image; and
generate, using the colorization machine-learning model, a second color image with a same camera pose as the second camera pose based on the reference color image, the second grayscale image, and the first color image.

9. The media of claim 8, wherein the first camera pose has a first viewpoint different from a second viewpoint associated with the third camera pose.

10. The media of claim 8, wherein the one or more computer-readable non-transitory storage media is further operable when executed to:
convert, using a visual geometry group, the first grayscale image to a first feature map and the reference color image to a second feature map; and
determine a spatial correspondence between the first feature map and the second feature map to generate a correlation map.

11. The media of claim 10, wherein the one or more computer-readable non-transitory storage media is further operable when executed to:
warp color information from the reference color image to the first grayscale image based on the correlation map to generate a warped color image; and
generate a confidence map indicating the reliability of a sampling of a reference color for each position of the warped color image, wherein generating the first color image is further based on the warped color image and the confidence map.

12. The media of claim 8, wherein the colorization machine-learning model is an encoder-decoder convolutional architecture.

13. The media of claim 8, wherein generating the first color image is further based on one or more previously generated color images associated with the first camera pose.

14. The media of claim 8, wherein generating the second color image is further based on one or more previously generated color images associated with the second camera pose.

15. A system comprising:
one or more processors; and
one or more computer-readable non-transitory storage media coupled to one or more of the processors and comprising instructions operable when executed by one or more of the processors to cause the system to:
capture a first grayscale image using a first camera at a first camera pose and a second grayscale image using a second camera at a second camera pose;
capture a reference color image using an RGB camera at a third camera pose;
generate, using a colorization machine-learning model, a first color image with a same camera pose as the first camera pose based on the reference color image and the first grayscale image; and
generate, using the colorization machine-learning model, a second color image with a same camera pose as the second camera pose based on the reference color image, the second grayscale image, and the first color image.

16. The system of claim 15, wherein the first camera pose has a first viewpoint different from a second viewpoint associated with the third camera pose.

17. The system of claim 15, wherein the one or more computer-readable non-transitory storage media is further operable when executed to:
convert, using a visual geometry group, the first grayscale image to a first feature map and the reference color image to a second feature map; and
determine a spatial correspondence between the first feature map and the second feature map to generate a correlation map.

18. The system of claim 17, wherein the one or more computer-readable non-transitory storage media is further operable when executed to:
warp color information from the reference color image to the first grayscale image based on the correlation map to generate a warped color image; and
generate a confidence map indicating the reliability of a sampling of a reference color for each position of the warped color image, wherein generating the first color image is further based on the warped color image and the confidence map.

19. The system of claim 15, wherein the colorization machine-learning model is an encoder-decoder convolutional architecture.

20. The system of claim 15, wherein generating the first color image is further based on one or more previously generated color images associated with the first camera pose.
